(19) United States
(12) Patent Application Publication
(10) Pub. No.: US 2008/0276176 A1
(43) Pub. Date: Nov. 6, 2008

(54) Guestbook

(76) Inventors: Avram Wahba, Westborough, MA (US); Hany Farag, Issaquah, WA (US)

Correspondence Address: ROBERT PLOTKIN, PC, 45 BUTTERNUT CIRCLE, CONCORD, MA, 01742-1937, US

(21) Appl. No.: 12/123,348

(22) Filed: May 19, 2008

(51) Int. Cl. G06F 3/048

(52) U.S. Cl. 715/730

(57) ABSTRACT

A computer-implemented system automatically creates electronic guestbooks using a computer-based guestbook creation system, which includes a computer (such as a tablet computer) and a digital camera connected to the computer. The guestbook creation system is provided at a particular location attended by guests, such as the banquet hall where a wedding reception is held. Each guest provides content using the computer, such as by using a stylus to write a congratulatory message to the bride and groom. The digital camera captures a digital image of the guest. The computer correlates the signature of each guest with the digital image of that guest to create a guestbook entry for each guest. A multimedia guestbook is created from these guestbook entries. Each entry displays information such as the digital image of the guest and the guest's comments.

### BACKGROUND

Guestbooks and similar books for signing by multiple parties are popular items at events such as weddings, graduations, and other celebrations, at inns and other vacation destinations, and at conferences, seminars, and other events. Typically a guestbook is created by requiring each guest to manually print and sign his or her name in the guestbook, and optionally to manually write additional comments (such as congratulations for the bride and groom at a wedding or suggestions for improvement at an inn). The resulting guestbook simply contains the resulting list of names and other information written by the guests.

### SUMMARY

A computer-implemented system automatically creates an electronic guestbook using a computer-based guestbook creation system, which includes a computer (such as a tablet computer) and a digital camera connected to the computer. The guestbook creation system is provided in conjunction with a particular location (such as an inn) or a particular event (such as a wedding). In the case of an event, the guestbook creation system is provided for use at the location of the event, such as a banquet hall where a wedding reception is held. Each guest uses the guestbook creation system to provide content for use in that guest's guestbook entry. Such content may, for example, be written comments from a wedding guest to the bride and groom, provided by the guest using a stylus applied to a touch screen of the computer. The digital camera captures a digital image of the guest.

The computer correlates the content provided by the guest with the digital image of the guest to create a guestbook entry for the guest. The entry may contain additional information, such as the guest's name. Multiple guests may create guestbook entries for themselves by following the same procedure.

A multimedia guestbook is created from the guestbook entries generated for the guests in the manner described above. Each guestbook entry may, for example, be represented in the multimedia guestbook as a single page corresponding to a particular guest. That page may display the digital image of the guest and the comments provided by the guest. The page may be formatted automatically according to a predetermined template format. The multimedia guestbook may be stored in a computer-readable medium, such as a hard disk, CD, or DVD, and copied and/or transported to other computers for subsequent viewing.

For example, one embodiment of the present invention is directed to a computer-implemented method comprising: (A) capturing a first image of a first user of a computer system; (B) receiving first content provided as input by the first user using an input device coupled to the computer system; (C) capturing a second image of a second user of the computer system; (D) receiving second content provided as input by the second user using the input device coupled to the computer system; (E) correlating the first image with the first content; (F) correlating the second image with the second content; and (G) creating a multimedia presentation in which the first image is associated with the first content and the second image is associated with the second content.

Other features and advantages of various aspects and embodiments of the present invention will become apparent from the following description and from the claims.

### BRIEF DESCRIPTION OF THE DRAWINGS

FIG. 1 is a dataflow diagram of a guestbook creation system according to one embodiment of the present invention;

FIG. 2A is a flowchart of a method performed by the guestbook creation system of FIG. 1 to create guestbook entries according to one embodiment of the present invention;

FIG. 2B is a flowchart of a method performed by the guestbook creation system of FIG. 1 to create a multimedia guestbook according to one embodiment of the present invention;

FIG. 3 is a diagram of a data structure for storing a guestbook entry according to one embodiment of the present invention;

FIG. 4A is a diagram of a user interface for receiving content to store in a guestbook entry according to one embodiment of the present invention; and

FIG. 4B is a diagram of a user interface for displaying a page in a multimedia guestbook according to one embodiment of the present invention.

### DETAILED DESCRIPTION

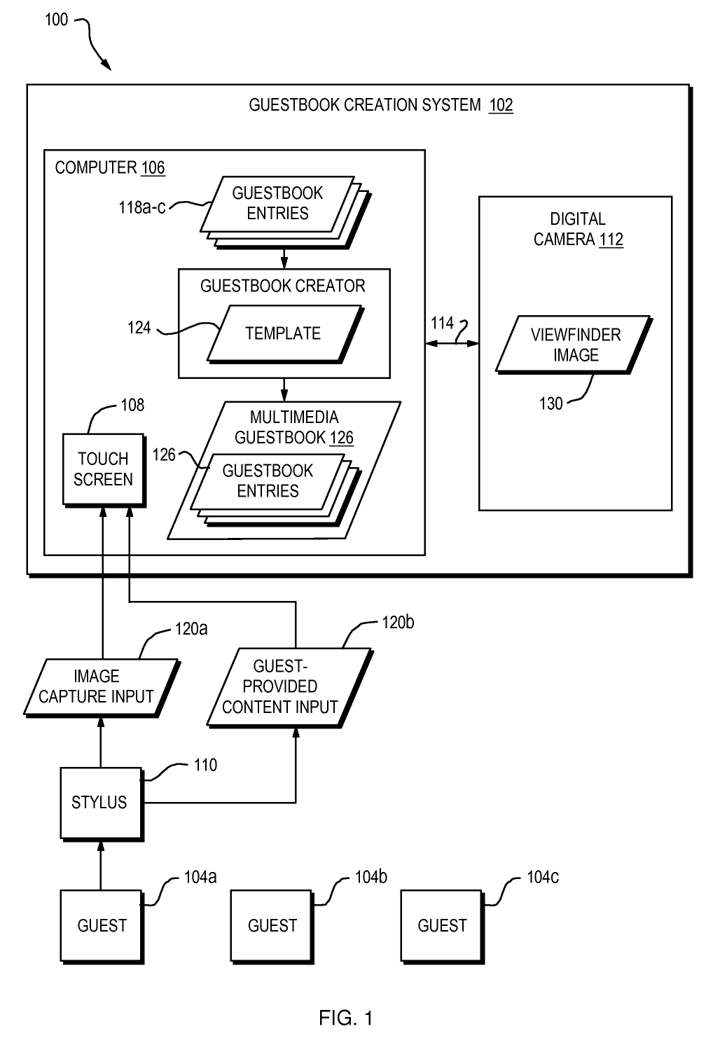

Referring to FIG. 1, a functional block diagram is shown of a guestbook creation system 102 according to one embodiment of the present invention. The system 102 is provided for use in conjunction with a particular location 100 attended by guests 104a-c, such as an inn or a banquet hall where a wedding reception is held. More generally, the system 102 may be provided for use in conjunction with an event, such as a wedding, attended by guests 104a-c, even if that event occurs at multiple disparate locations. Although three guests 104a-c are shown in FIG. 1 for purposes of example, guestbook creation systems implemented according to embodiments of the present invention may be used in conjunction with any number of guests.

The guestbook creation system 102 includes a computer 106. Although the computer 106 may be any kind of computer, in the embodiment illustrated in FIG. 1, the computer is a tablet computer having a touch screen 106 capable of receiving input from guests 104a-c using a stylus 110. The touch screen 106 may be any kind of touch screen, and may be capable of receiving input from any kind of input mechanism instead of or in addition to the stylus 110, such as a human finger. Furthermore, the stylus 110 is merely one example of an input device that the guests 104a-c may use to provide input to the system 102. For example, the guests 104a-c may provide input to the system 102 using input devices such as a keyboard, mouse, touchpad, microphone, or any combination thereof.

The guestbook creation system 102 also includes a digital camera 112 which is capable of capturing digital images of the guests 104a-c. The digital camera 112 may be any kind of digital camera, including a digital camera capable of capturing still images, full-motion video, audio, or any combination thereof from the guests 104a-c. The digital camera 112 is coupled to the computer 106 over a communication link 114, which may be any kind of communication link, such as a wired communication link (implemented, for example, using a cable or docking station) or a wireless communication link. The digital camera 112 may transmit any data that it captures to the computer 106 over the communication link 114. The computer 106 may also transmit data and/or control signals, such as instructions to transmit or delete data, to the digital camera 112 over the communication link 114. The computer 106 and digital camera 112 may be implemented in a single device, such as a tablet computer having a built-in digital camera, in which case the communication link 114 may be internal to the device.

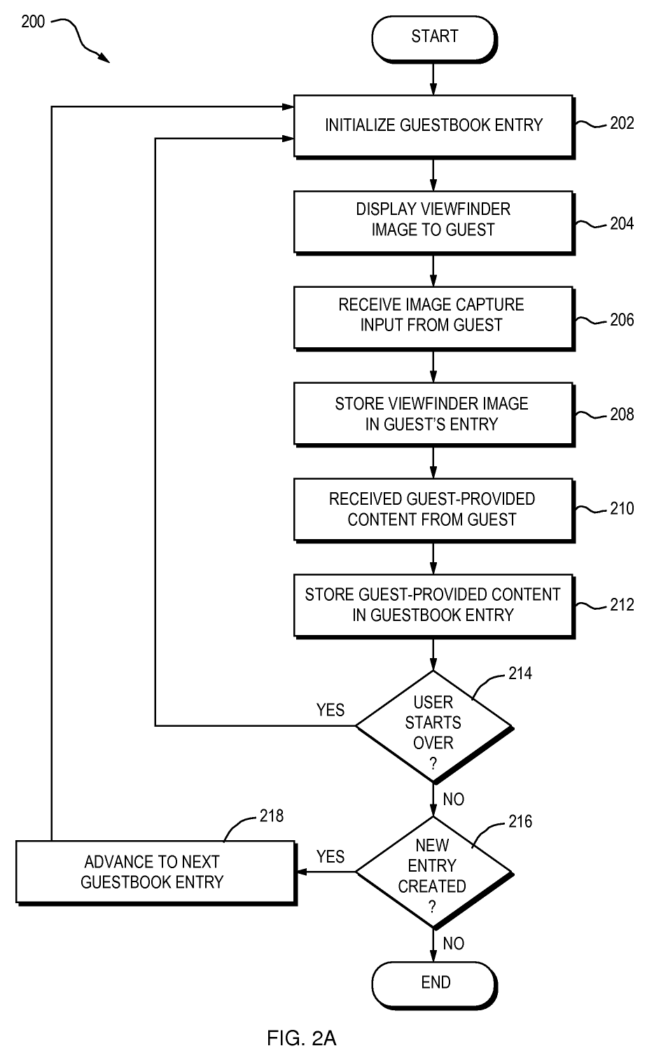

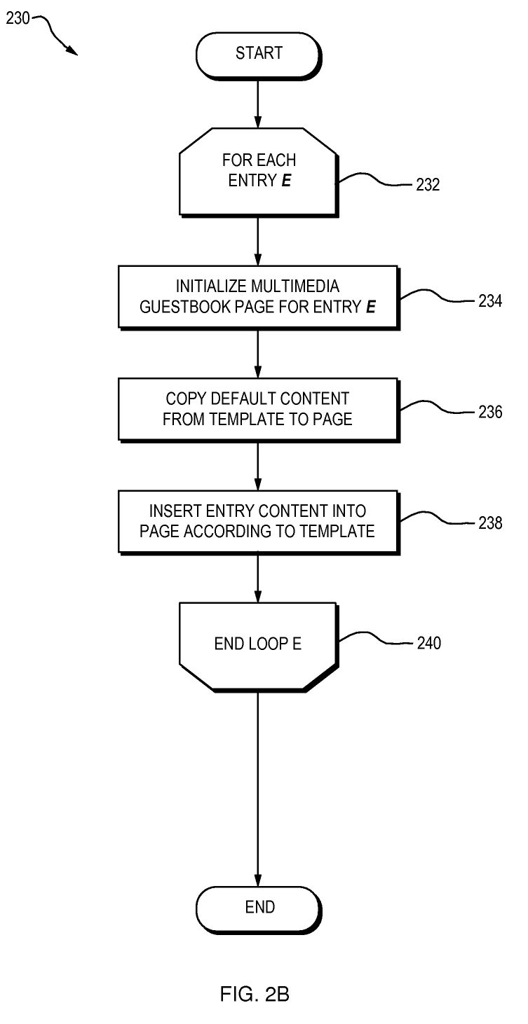

As will now be described in more detail, the system 102 creates a plurality of guestbook entries 118a-c, corresponding to the plurality of guests 104a-c, respectively. More specifically, entry 118a corresponds to guest 104a, entry 118b corresponds to guest 104b, and entry 118c corresponds to guest 104c. Referring to FIG. 2A, a flowchart is shown of a method 200 that is performed by the guestbook creation system 102 according to one embodiment of the present invention to create the guestbook entries.

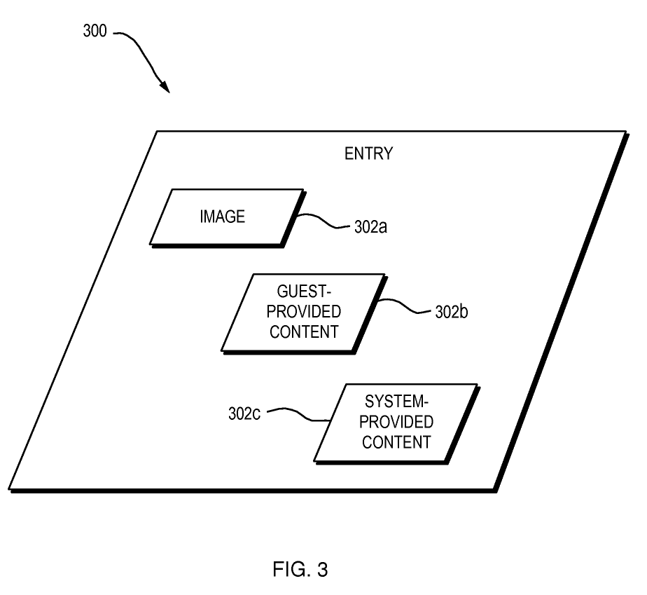

An example of a data structure that may be used to store guestbook entry 118a is shown in FIG. 3. Data structures having the same format may be used to store guestbook entries 118b and 118c. The data structure shown in FIG. 3 includes three fields: an image field 302a for storing a digital image of guest 104a, a guest-provided content field 302b for storing content provided by the guest 104b, and a system-provided content field 302c for storing content provided by the system 102 which relates to guest 104a. Each of these fields 302a-c will be described in more detail below.

Upon initialization of the system 102, the system 102 initializes the first guestbook entry 118a (FIG. 2A, step 202). In its initialized state, all of the fields 302a-c of the guestbook entry data structure 118a may, for example, include null values. Although the following description explains how data relating to guest 104a are stored in entry 118a, the same procedure may be followed to store data relating to guests 104b-c in entries 118b-c, respectively.

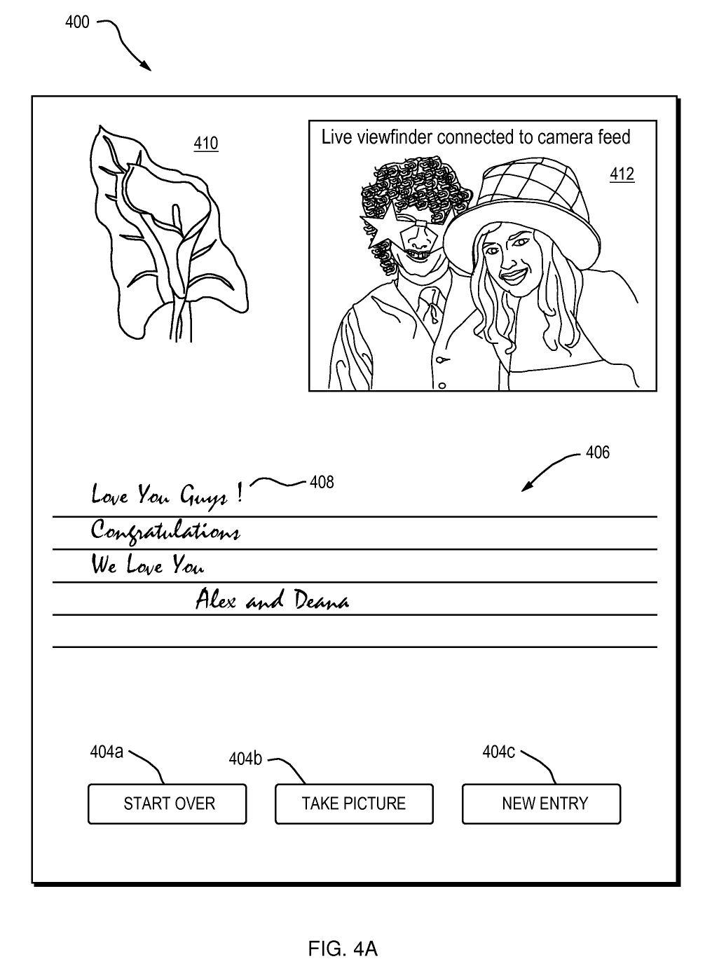

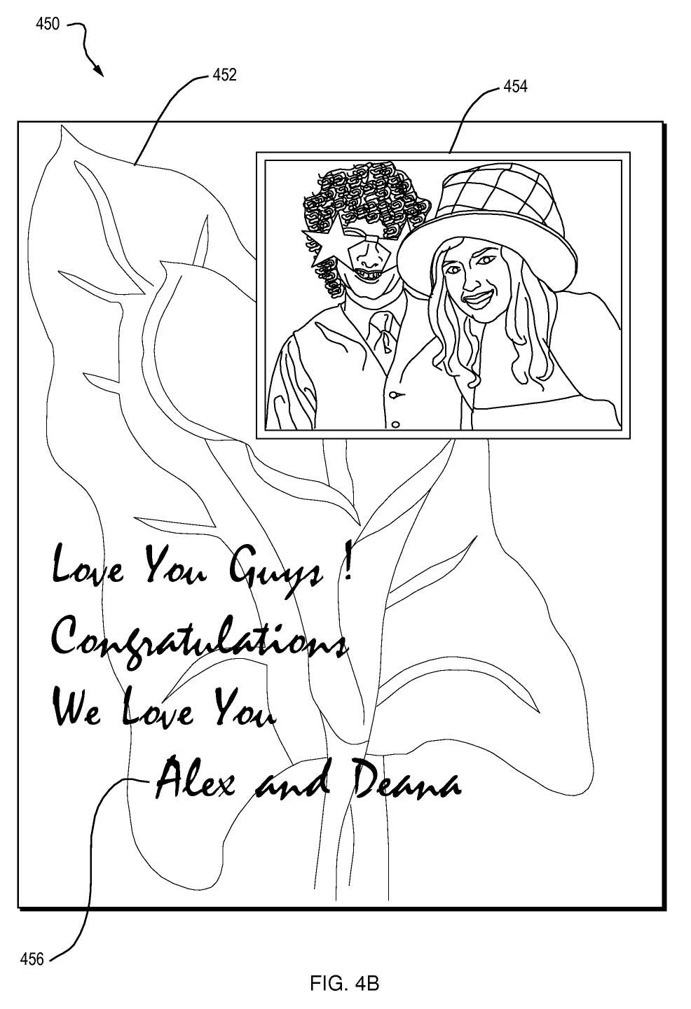

As shown in FIG. 4A, the computer 106 may provide a graphical user interface 400 on the touch screen 108 or other display device. The user interface 400 includes a region 402 dedicated to displaying a continuously-updated image representing the current view 130 seen through a viewfinder of the digital camera 112 (FIG. 2A, step 204). As a result, when guest 104a approaches the guestbook creation system 102 and stands in front of the digital camera 112, guest 104a sees a continuously-updated image of himself/herself in the region 402 of the user interface 400 on the touch screen 108. When the guest 104a is satisfied with the image displayed in region 402, the guest 104a may provide image capture input 120a to the system 102 (FIG. 2A, step 206), such as by depressing the stylus 110 on a “Take Picture” button 404b displayed in the user interface 400. In response to receiving the image capture input 120a, the computer 106 may store the image currently displayed in region 402 in field 302a (FIG. 3) of the entry 118a corresponding to guest 104a (FIG. 2A, step 208).

The system 102 may make modifications to the image 302a of the guest 118a in any of a variety of ways. For example, the system 102 may make automatic adjustments to the image 302a, such as by automatically applying predetermined adjustments to hue, brightness, contrast, or other features of the image 302a. As another example, the system 102 may enable the guest 104a to manually modify the image 302a in any of a variety of ways, such as by manually applying adjustments to features of the image 302a, and/or by drawing on the image 302a using the stylus 110. Any such modifications to the image 302a may be saved within the image 302a in the guestbook entry 118a.

Although the guestbook entry 118a shown in FIG. 3 includes only a single image of the guest 104a, this is merely an example and does not constitute a limitation of the present invention. Rather, for example, the entry 118a may include multiple still images of the guest 104a, full-motion video of the guest 104a, audio of the guest 104a (such as the guest's voice), or any combination thereof. Furthermore, the digital camera 112 is only one example of a content capture device that may be used to capture content from the guest 104a. Other examples include but are not limited to microphones, scanners, and digital media readers. Therefore, the image field 302a shown in FIG. 3 may more generally be used to store any captured content related to the guest 104a.

User interface 400 also includes a region 406 dedicated to receiving and displaying content provided by the guest 104a for inclusion in the guest's guestbook entry 118a. Initially, the region 406 may be displayed as an empty box, a set of blank lines, or other area devoid of content. The guest 104a may provide guest-provided content input 120b through the touch screen, such as by handwriting comments on the touch screen 108 using the stylus 110 (FIG. 2A, step 210). As the guest 104a provides the input 120b, the content of the input 120b may be displayed within the region 406. For example, in the embodiment illustrated in FIG. 4A, the guest-provided content input 120b is text 408, handwritten by the guest 104a using the stylus. Such text 408 may be displayed in the region 406 as the guest 104a writes such text, thereby simulating real-time writing on the touch screen 108 as if the touch screen 108 were paper. The input 120b provided by the guest 104a may, for example, be stored in field 302b of the guest's guestbook entry 118a (FIG. 3) as the guest 104a provides the input 120b (FIG. 2A, step 212).

If the guest 104a is dissatisfied at any point with the contents of the guest's entry 118a, such as the guest's image 302a (displayed in region 402) and/or the content 302b provided by the guest 104a (displayed in region 406), the guest 104a may depress a “Start Over” button 404a in the user interface 400 (FIG. 2A, step 214), thereby causing the computer 106 to erase the contents of regions 402 and 406, and to erase the contents of the guest's entry 118a. The guest 104a may then repeat the procedure described above (beginning at step 202 in FIG. 2A) until the guest 104a is satisfied with the contents of the entry 118a.

Once the guest 104a is satisfied with the contents of the entry 118a, the guest 104a may either simply stop entering data through the user interface 400, since the data (e.g., image 302a and guest-provided content 302b) entered by the guest 104a have already been saved in the guest's guestbook entry 118a. The next guest 104b may then depress a “New Entry” button 404c in the user interface 400, in response to which the computer 106 may prepare itself to receive input from the next guest 104b by advancing to the next entry 118b in the guestbook (FIG. 2A, step 218) and clearing the contents of the image region 402 and comments region 406. Any subsequent input entered through the user interface 400 will then be stored in the entry 118b for the next guest 104b. Alternatively, for example, the first guest 104a may depress the “New Entry” button 404c upon completing input of his entry 118a (FIG. 2A, step 216), thereby preparing the system 102 for input to be provided by the next guest 104b (FIG. 2A, step 218) without any possibility that the next guest 104b will override data input by the previous guest 104a.

The user interface 400 may include additional content which is not included in any of the guestbook entries 118a-c. For example, the user interface 400 may include a background region 410 for displaying a predetermined background image, such as an image of the bride and groom at a wedding, regardless of which of the guests 104a-c is providing input to the guestbook creation system 102 through the user interface 400. Such a background image may be displayed to provide a pleasing appearance to the guests 104a-c, but such image need not be stored in any of the guestbook entries themselves 118a-c. Other examples of content which may be provided by the user interface 400 but which need not stored in the guestbook entries 118a-c include, for example, a welcome message from the bride and groom, textual and/or audio instructions for creating a guestbook entry, and a thank-you message from the bride and groom upon completion of each guestbook entry.

Furthermore, the guestbook creation system 102 may automatically store certain information in the guestbook entries 118a-c, even though such information was not input by any of the guests 104a-c. For example, the bride and groom at a wedding may pre-configure the guestbook creation system 102 to include a list of all guests who are scheduled to attend their wedding. When one of the guests approaches the guestbook creation system 102, the system 102 may enable the guest to identify himself or herself to the system 102. For example, the guest may select his or her name from a predetermined list of guests. As a result, the computer 106 may store the guest's name in the guest's guestbook entry.

As another example, the system 102 may begin by displaying the name of the first guest on the guest list and prompting that guest to create an entry in the guestbook 116. Guests at the wedding may then approach the guestbook creation system 102 and determine whether their name is displayed. When a guest sees his or her name displayed, the guest may create an entry for himself or herself. The computer 106 may then store the guest's name within the system-provided content field 302c of the guest's guestbook entry. In this scenario, the guest's name is stored within the guest's guestbook entry without requiring the guest to enter or select his or her name using the system 102. The guest's name is merely one example of system-provided content that may be stored in the system-provided content field 302c of the guestbook entry 118a.

Identifying the name of the guest who is currently creating an entry in any of the ways described above may enable additional features to be implemented in the system 102. For example, once the system 102 identifies the name of the guest currently using the system 102, the system 102 may display a predetermined and personalized welcome message from the bride and groom to that guest.

Although in the method 200 described above with respect to FIG. 2A data are stored in the guestbook entries 118a-c as the guests 104a-c provide that data to the system 102, this is merely an example and does not constitute a limitation of the present invention. There may, for example, be a delay between capturing of a guest's image and storage of that image in the guest's guestbook entry. Similarly, for example, there may be a delay between input of content (e.g., written comments) by a guest and storage of that content in the guest's guestbook entry. For example, the image of guest 104a and the content (e.g., written comments) provided by guest 104a may not be stored in guestbook entry 118a until guest 104a (or someone else) depresses the “New Entry” button 404c.

As another example, the system 102 may capture images for some or all of the guests 104a-c and associate a timestamp with each such image. Similarly, the system 102 may receive content (e.g., written comments) from some or all of the guests 104a-c and associate a timestamp with each such content. At some point in the future, the system 102 may correlate the timestamps of the images with the timestamps of the guest-provided contents to match the image of guest 104a with the content provided by guest 104a, and to do the same for guests 104b and 104c.

In addition to or instead of timestamps, the system 102 may use other kinds of identifiers to correlate images with guest-provided content. For example, upon initialization of the system 102, the system 102 may assign an entry number of zero to all content received in conjunction with guest 104a (such as the image of the guest and the comments provided by the guest). Such entry numbers may be used to correlate images with guest-provided content at a subsequent time, and thereby to create entries 118a-c corresponding to the guests 104a-c.

Furthermore, discrete entries 118a-c need not be created for each of the guests 104a-c. For example, as described above a set of digital images, corresponding to guests 104a-c, may be captured and stored. As further described above, a set of guest-provided content, corresponding to guests 104a-c, may be received and stored. Such images and content may be stored separately from each other, instead of being combined into entries corresponding to the guests 104a-c.

The guestbook entries 118a-c (or other form in which the images and guest-provided content are stored) may be used to generate a multimedia guestbook for playback at a subsequent time. Referring to FIG. 2B, a flowchart is shown of a method 230 that is used to create such a multimedia guestbook 126 according to one embodiment of the present invention.

The guestbook creation system 102 includes a multimedia guestbook creator 122, which includes or otherwise has access to a guestbook page template 124, which defines the layout of a guestbook page. The template 124 may, for example, define the absolute or relative locations of the image 302a and the guest-provided content 302b, and of any other content to be provided on guestbook pages. The layout defined by the template 124 may be different from the layout of the user interface 400 shown in FIG. 4A.

The following description of FIG. 2B will assume for purposes of example that the guestbook content has been stored in guestbook entries 118a-c. The method 230 of FIG. 2B enters a loop over each of the guestbook entries 118a-c (step 232). For each entry E, the method 230 initializes a guestbook page, in the multimedia guestbook 126, corresponding to entry E (step 234). The method 230 inserts any default content (such as a background image) from the template 124 into the current page (step 236).

The method 230 then inserts content from entry E into the current guestbook page, according to the layout specified by the template 124 (step 236). For example, if the template 124 indicates that images are to be located at coordinates (X, Y), the method 230 inserts the image 302a from entry 118a (FIG. 3) into the current page at coordinates (X, Y). Steps 234-2348 are repeated for the remaining entries E (step 240). The result of steps 234-238 is a page, corresponding to one of the guests 104a-c, which contains optional default content and the content from that guest's guestbook entry, laid out according to the template 124.

An example of such a page 450 is shown in FIG. 4B. Assume for purposes of example that the page 450 shown in FIG. 4B corresponds to the first guest 104a. The page 450 includes default background content 452 (such as images of the bride and groom), copied from the template 124, which is included in every page of the guestbook 126. The page 450 also includes image 454, which is copied from the image 302a field of the guestbook entry 118a of guest 104a. Image 454 is located at coordinates specified by the template 124. The page 450 also includes comments 456, which are copied from the guest-provided content field 302b of the guestbook entry 118a of guest 104a. Comments 456 are located at coordinates specified by the template 124.

Steps 234-238 are repeated for the remaining guestbook entries 118b-c. The result is the multimedia guestbook 126, which contains a plurality of pages 128a-c corresponding to the plurality of guests 104a-c.

The multimedia guestbook 126 may be stored and played back in any of a variety of ways. For example, the guestbook 126 may be generated and displayed on the fly. In other words, individual pages in the guestbook 126 may be generated and displayed before all of the pages in the guestbook have been generated. For example, the system 102 may display a guest's page to that guest immediately after the guest has approved of the content of the guest's guestbook entry.

The multimedia guestbook 126 may be stored in any format, such as a PowerPoint presentation or other slideshow, a movie file (such as a file stored in any version of the MPEG format), or as a series of still images in any format (such as JPG, GIF, or PDF). The guestbook may be stored in a file in a computer hard disk, CD, DVD, or other medium, from which it may be copied and/or played back directly. For example, if the guestbook 126 may be stored on a DVD in a format suitable for direct playback in a DVD player. As another example, the guestbook 126 may be stored in Adobe Flash format or other format suitable for playback on a web site. As another example, each page of the guestbook 126 may be stored as an HTML page, thereby enabling the guestbook 126 to be stored and viewed as a web site in which each of the pages 128a-c in the guestbook is represented as a distinct HTML page.

As yet another example, the guestbook 126 may be transferred to Shutterfly.com or other web site for hosting digital photographs, from which the guestbook 126 may be viewed. As a further example, the guestbook 126 may be published to a social networking web site (such as Facebook.com or MySpace.com) as an entry on a personal page of the bride and groom or other person associated with the event/location of the guestbook. The guestbook creation system 102 may automatically tag every person in every picture based on data that is input at capture time. For example, when a guest is creating his or her entry, the guest may tag himself or herself in the picture. The guestbook creation system 102 may automatically propagate the tagging information to the social networking site (e.g., Facebook.com or MySpace.com).

The guestbook 126 may be played back on any device, such as a personal computer (either the computer 106 that was used to create the guestbook 126 or another computer) or a television. Content in the guestbook 126 need not be played back in the same mode as that in which it was stored. For example, text written by a guest may be played back as audio using text-to-speech conversion software. Conversely, audio spoken by a guest may instead be displayed as text using speech-to-text (speech recognition) software.

Embodiments of the present invention have a variety of advantages. For example, embodiments of the electronic guestbook creation system disclosed herein are as easy for guests to use as a paper guestbook. Guests lacking any computer skills may use the system to create guestbook entries for themselves. Furthermore, those who wish to create guestbooks for their weddings, businesses, or other events/locations need not have any computer skills to create such guestbooks using embodiments of the present invention. Attempting to create such a guestbook merely using off-the-shelf components, such as a tablet computer and digital camera, would fail to work because, for example, such an off-the-shelf solution would not correlate images of guests with content (e.g., written comments) provided by those guests.

Furthermore, the embodiments disclosed herein have a variety of advantages over systems which would attempt to use a human photographer to create a guestbook in which photographs of guests were correlated with comments written by those guests in a paper-based guestbook. If a human photographer were to attempt to create such a guestbook, that photographer would need to correlate the photograph of each guest with that user's written comments. Such correlation would be tedious, time-consuming, and prone to error. For example, the photographer might fail to accurately match a photograph with its corresponding comments if one guest skipped a page when writing comments, and the next guest wrote his or her comments in the previous, blank page. Embodiments of the present invention avoid these and other problems with manual systems for creating guestbooks which contain both images of guests and content provided by those guests.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The term “guest” as used herein is not limited to a single person. Rather, a “guest” may be one or more people or other subjects, such as an animal, statue, or other object. For example, the digital camera 112 may capture an image of multiple people who are collectively treated as a single “guest” for purposes of the guestbook entries 118a-c and the guestbook 126.

Although the guest-provided content 120b includes written comments in some of the examples described above, this is not a limitation of the present invention. Rather, the guest-provided content 120b may include any content, such as text, graphics, video, audio, or any combination thereof. Such content may be stored in multiple fields and/or formats, rather than merely in the single field 302b shown in FIG. 3. More generally, the data structure shown in FIG. 3 for storing the content of a guestbook entry is merely an example and does not constitute a limitation of the present invention.

The particular user interface 400 shown in FIG. 4A is merely an example and does not constitute a limitation of the present invention. Rather, any user interface(s) may be used to obtain input from the guests 104a-c. Similarly, the particular layout shown in FIG. 4B is merely an example and does not constitute a limitation of the present invention. Rather, any template(s) may be used to generate the pages 128a-c of the guestbook 126. More generally, pages 128a-c in the guestbook need not be generated from templates, but rather may be generated in any manner. Furthermore, the guestbook 126 need not include one page per guest. For example, content for multiple guests may be included on a single page. As another example, content for a single guest may be spread across multiple pages.

Although in certain embodiments described above, all of the content for each guest's guestbook entry is received by the system 102 before receiving any content for a subsequent guest's entry, this is not a requirement of the present invention. For example, multiple guests 104a and 104b may write comments for their guestbook entries, and optionally approve of digital images of themselves to be included in their guestbook entries. Assuming that the guests 104a and 104b are guests of a wedding, the guests 104a and 104b may attend the wedding, during which additional photographs of guests 104a and 104b are taken (e.g., by a professional photographer). Guests 104a and 104b may return to the guestbook creation system 102 and browse through such additional photographs, and then include one or more of such photographs within their own guestbook entries before finalizing those entries. This scenario enables the guests 104a and 104b to defer their final choice of photograph until a wider range of photographs are available from which to choose.

Although in certain examples described above the system 102 is used in conjunction with a wedding, this is not a requirement of the present invention. Rather, the guestbook creation system 102 may be used in conjunction with any location or event, such as, for example, any party or celebration, graduation, conference, seminar, retail sale event, or grand opening. The system 102 may be used in conjunction with a particular location that is not associated with any event. For example, the system 102 may be used to create a guestbook for all customers who shop at a store within a particular period of time (e.g., one week). There need not, however, be any temporal limitation on the contents of the guestbook. For example, if the guestbook is associated with an inn, a new guestbook entry may be added to the guestbook each time a guest visits the inn.

Elements of the guestbook creation system 102 need not be contained within a single computer and/or digital camera. For example, several guestbook creation systems of the type shown in FIG. 1 may be provided at a single wedding so that multiple guests may create entries simultaneously. The information gathered and generated by such systems may be combined together into a single guestbook in any of a variety of ways, such as by transmitting such information to a central computer which operates in the manner shown in FIG. 1.

Some or all of the functions performed by the system 102 of FIG. 1 may be performed over a network rather than on the computer 106. For example, computer 106 need not store the guestbook entries 118a-c and/or the guestbook 126. Instead, the computer 106 may acts as a client to receive digital images from the camera 112 and to receive input from the guests 104a-c, and to upload the images and guest input over a network to a server or other computer which performs the functions described herein. For example, guests of a wedding who are not in attendance at the wedding may use a remote computer and a remote digital camera (e.g., a webcam) to log in to a web-based service which provides them with a user interface, such as the user interface 400 shown in FIG. 4A, and enables them to perform the functions disclosed herein over the Internet rather than locally at the guestbook creation system 102.

Techniques disclosed herein may be used in a variety of other contexts. For example, one or more users may use the guestbook creation system as a blog/diary. As another example, a journalist in the field may use the guestbook creation system 102 to take notes of events. As yet another example, an employer may use a system of the kind disclosed herein to log employees in and out of the employer's facilities. In this scenario, the stylus may be used to collect signatures, and the image (with a timestamp) may be used to confirm that each employee arrived at and left the facilities at the time claimed by the employee. Similarly, a system of the kind disclosed herein may be used for auditing purposes, such as to identify who arrived at and left a particular secured location. Written signatures may be combined with other biometrics (such as fingerprinting) to provide an elegant and simple security solution.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) capturing a first image of a first user of a computer system;
(B) receiving first content provided as input by the first user using an input device coupled to the computer system;
(C) capturing a second image of a second user of the computer system;
(D) receiving second content provided as input by the second user using the input device coupled to the computer system;
(E) correlating the first image with the first content;
(F) correlating the second image with the second content; and
(G) creating a multimedia presentation in which the first image is associated with the first content and the second image is associated with the second content.

2. The method of claim 1, wherein (A) comprises capturing the first image with a digital camera.

3. The method of claim 1, wherein (B) comprises receiving the first content using a touch screen.

4. The method of claim 3, wherein (B) comprises receiving the first content using a stylus applied to a touch screen.

5. The method of claim 1, wherein (A) comprises identifying a time A at which the first image is captured by the computer system, wherein (B) comprises identifying a time B at which the first content is provided as input by the second user, and wherein (E) comprises correlating the first image with the first content based on times A and B.

6. A computer-implemented system comprising:
means for capturing a first image of a first user of a computer system;
means for receiving first content provided as input by the first user using an input device coupled to the computer system;
means for capturing a second image of a second user of the computer system;
means for receiving second content provided as input by the second user using the input device coupled to the computer system;
means for correlating the first image with the first content;
means for correlating the second image with the second content; and
means for creating a multimedia presentation in which the first image is associated with the first content and the second image is associated with the second content.

7. The system of claim 6, wherein the means for capturing the first image comprises means for capturing the first image with a digital camera.

8. The system of claim 6, wherein the means for receiving the first content comprises means for receiving the first content using a touch screen.

9. The system of claim 8, wherein the means for receiving the first content comprises means for receiving the first content using a stylus applied to a touch screen.

10. The system of claim 6, wherein the means for capturing the first image comprises means for identifying a time A at which the first image is captured by the computer system, wherein the means for receiving the first content comprises identifying a time B at which the first content is provided as input by the second user, and wherein the means for correlating the first image with the first content comprises means for correlating the first image with the first content based on times A and B.
